(19) United States
(12) Patent Application Publication
(10) Pub. No.: US 2026/0274251 A1
(43) Pub. Date: Sep. 17, 2026

(54) VEHICLE CONTROL APPARATUS, VEHICLE CONTROL METHOD, AND VEHICLE CONTROL PROGRAM

(71) Applicants: DENSO CORPORATION, Kariya-city (JP); TOYOTA JIDOSHA KABUSHIKI KAISHA, Toyota-shi (JP)

(72) Inventors: Yasuhiro IMAI, Tokyo (JP); Yui TASHIRO, Hadano-shi (JP)

(21) Appl. No.: 19/560,770

(22) Filed: Mar. 9, 2026

(30) Foreign Application Priority Data
Mar. 13, 2025 (JP) 2025-040342

(51) Int. Cl. B60W 30/09; B60W 30/095; B60W 30/14; B60W 30/18; G06V 20/58

(52) U.S. Cl. CPC B60W 30/09; B60W 30/0956; B60W 30/143; B60W 30/18163; G06V 20/58; B60W 2420/403; B60W 2554/4044; B60W 2554/4045

(57) ABSTRACT

A vehicle control apparatus includes a lane-change determiner, an adjacent-vehicle detector, a cut-in determiner, and an acceleration/deceleration controller. The lane-change determiner determines whether an ego vehicle performs a lane change, based on an input signal from a vehicle-mounted device. The adjacent-vehicle detector detects an adjacent vehicle traveling in the same direction as the ego vehicle in a lane adjacent to a lane of the ego vehicle. The cut-in determiner determines whether the detected adjacent vehicle cuts in ahead of the traveling lane of the ego vehicle. The acceleration/deceleration controller executes acceleration/deceleration control for collision avoidance between the ego vehicle and the adjacent vehicle, and suppresses deceleration control when it is determined that the adjacent vehicle cuts in and it is determined that the ego vehicle performs a lane change. This suppresses the provision of an unnecessary feeling of deceleration to a driver of the ego vehicle during a lane change for avoiding the cut-in vehicle, and ensures safety and comfort in traveling.

### CROSS REFERENCE TO RELATED DOCUMENT

The present application claims the benefit of priority of Japanese Patent Application No. 2025-040342 filed on Mar. 13, 2025, the disclosure of which is incorporated in its entirety herein by reference.

### TECHNICAL FIELD

This disclosure relates generally to a vehicle control apparatus, a vehicle control method, and a vehicle control program.

### BACKGROUND ART

Japanese Patent First Publication No. 2022-165542 teaches a vehicle control device that executes acceleration/deceleration control of an own vehicle (which will also be referred to below as an ego vehicle) in order to avoid a collision between the ego vehicle and another vehicle when the other vehicle (i.e., a target vehicle) cuts in ahead of the ego vehicle in a traveling lane in which the ego vehicle is traveling. The vehicle control device described in the above publication obtains a relative relationship value between the ego vehicle and an adjacent vehicle traveling in a traveling lane adjacent to the traveling lane in which the ego vehicle is traveling, and executes acceleration/deceleration control of the ego vehicle when a cut-in of the adjacent vehicle into the front of the ego vehicle is detected using the relative relationship value.

Now, in a situation where an adjacent vehicle is attempting to cut in front of the ego vehicle as described above, the driver of the ego vehicle may change the traveling lane, that is, may perform a lane change, in order to avoid the adjacent vehicle. Hereinafter, for convenience of description, another vehicle that cuts in ahead of the ego vehicle will also be referred to below as a cut-in vehicle. When the driver of the ego vehicle is attempting to perform a lane change in order to avoid the cut-in vehicle, if deceleration control of the ego vehicle is executed as in the above-described vehicle control device, the driver may feel an unnecessary sense of deceleration more strongly, and traveling comfort may be impaired.

### SUMMARY

In view of the above points, it is an object of the present disclosure to provide a vehicle control apparatus, a vehicle control method, and a vehicle control program capable of suppressing an unnecessary sense of deceleration being given to a driver of an ego vehicle during a lane change for avoiding a cut-in vehicle, and ensuring safety and comfort in traveling.

According to one aspect of this disclosure, there is provided a vehicle control apparatus configured to control an operation of an ego vehicle, which comprises: (a) a lane-change determiner which determines whether the ego vehicle changes lanes using an input signal from a vehicle-mounted device of the ego vehicle; (b) an adjacent-vehicle detector which works to detect, in an adjacent lane adjacent to a lane in which the ego vehicle is traveling, an adjacent vehicle moving in the same direction as the ego vehicle; (c) a cut-in determiner which is configured to determine whether the adjacent vehicle is about to cut in ahead of the ego vehicle into the lane in which the ego vehicle is traveling; and (d) an acceleration/deceleration controller which works to execute acceleration control or deceleration control for the ego vehicle to avoid a collision between the ego vehicle and the adjacent vehicle. The acceleration/deceleration controller works to suppress the deceleration control when the cut-in determiner determines that the adjacent vehicle is attempting to perform a cut-in front of the ego vehicle and the lane-change determiner determines that the ego vehicle is attempting to perform a lane change.

Accordingly, when the adjacent vehicle cuts in ahead of the lane in which the ego vehicle is traveling, deceleration control is executed; however, when the ego vehicle performs a lane change, the deceleration control is suppressed. As a result, providing the driver with an unnecessary feeling of deceleration is suppressed, and the vehicle control apparatus ensures safety and comfort in traveling of the ego vehicle.

According to the second aspect of this disclosure, there is provided a vehicle control method executed by a vehicle controller installed in an ego vehicle, which comprises: (a) determining whether the ego vehicle changes lanes using an input signal from a vehicle-mounted device of the ego vehicle; (b) detecting, in a lane adjacent to a lane in which the ego vehicle is traveling, an adjacent vehicle traveling in the same direction as the ego vehicle; (c) determining whether the adjacent vehicle is attempting to perform a cut-in ahead of the ego vehicle into the lane in which the ego vehicle is traveling; and (d) executing deceleration control to avoid a collision between the ego vehicle and the adjacent vehicle. In executing the deceleration control, when it is determined that the adjacent vehicle performs the cut-in and it is determined that the ego vehicle changes lanes, the deceleration control is suppressed.

Accordingly, when the adjacent vehicle cuts in ahead of the lane in which the ego vehicle is traveling, deceleration control is executed; however, when the ego vehicle performs a lane change, the deceleration control is suppressed. As a result, providing the driver with an unnecessary feeling of deceleration is suppressed, and the vehicle control method ensures safety and comfort in traveling of the ego vehicle.

According to the third aspect of this disclosure, there is provided a vehicle control program executed by a vehicle controller installed in an ego vehicle. The vehicle control program causes the vehicle controller to execute: (a) a process of determining whether the ego vehicle changes lanes using an input signal from a vehicle-mounted device of the ego vehicle; (b) a process of detecting, in a lane adjacent to a lane in which the ego vehicle is traveling, an adjacent vehicle traveling in the same direction as the ego vehicle; (c) a process of determining whether the adjacent vehicle is attempting to perform a cut-in ahead of the ego vehicle into the lane in which the ego vehicle is traveling; and (d) a process of executing deceleration control to avoid a collision between the ego vehicle and the adjacent vehicle. In executing the deceleration control, when it is determined that the adjacent vehicle is attempting to perform the cut-in and it is determined that the ego vehicle changes lanes, the deceleration control is suppressed.

Accordingly, when the adjacent vehicle cuts in ahead of the lane in which the ego vehicle is traveling, deceleration control is executed; however, when the ego vehicle performs a lane change, the deceleration control is suppressed. As a result, the vehicle control program ensures safe and comfortable travel without causing the driver to feel unnecessary deceleration.

Reference numerals in parentheses attached to respective components and the like indicate an example of correspondence between the components and specific components referred to in embodiments to be described later.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram illustrating a vehicle control system according to an embodiment;

FIG. 2 is a flowchart illustrating an example of processing of vehicle control;

FIG. 3 is a diagram illustrating an example of a situation in which deceleration control is suppressed;

FIG. 4 is a diagram illustrating another example of a situation in which deceleration control is suppressed;

FIG. 5 is an explanatory diagram illustrating a change in an overlap ratio in a case where an ego vehicle is about to perform a lane change due to a cut-in by an adjacent vehicle; and

FIG. 6 is a diagram illustrating an example of a relationship between an overlap ratio and a deceleration in suppression of deceleration control.

### DESCRIPTION OF THE PREFERRED EMBODIMENTS

Hereinafter, an embodiment of the present disclosure will be described with reference to the drawings.

### First Embodiment

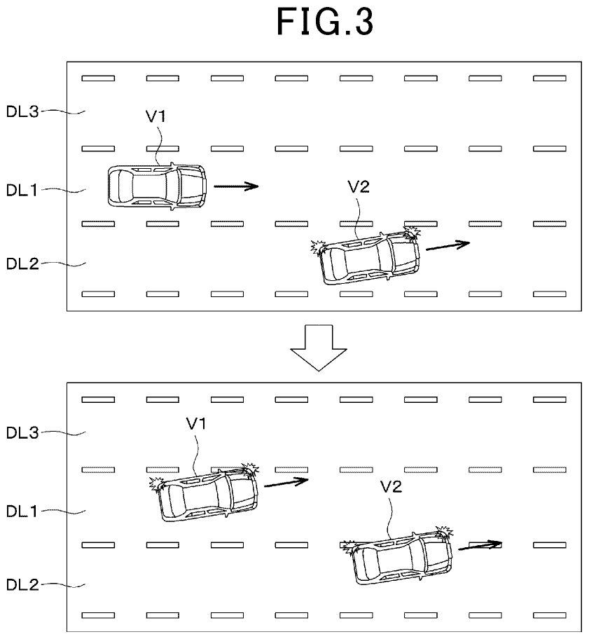

The vehicle control system 1 according to the first embodiment will be described. The vehicle control system 1 of the present embodiment is suitably applied to a vehicle such as a passenger automobile, but is of course also applicable to vehicles other than passenger automobiles. Hereinafter, as shown in FIG. 3 to be described later, the vehicle to which the vehicle control system 1 is applied will be referred to as the ego vehicle V1.

### Basic Configuration

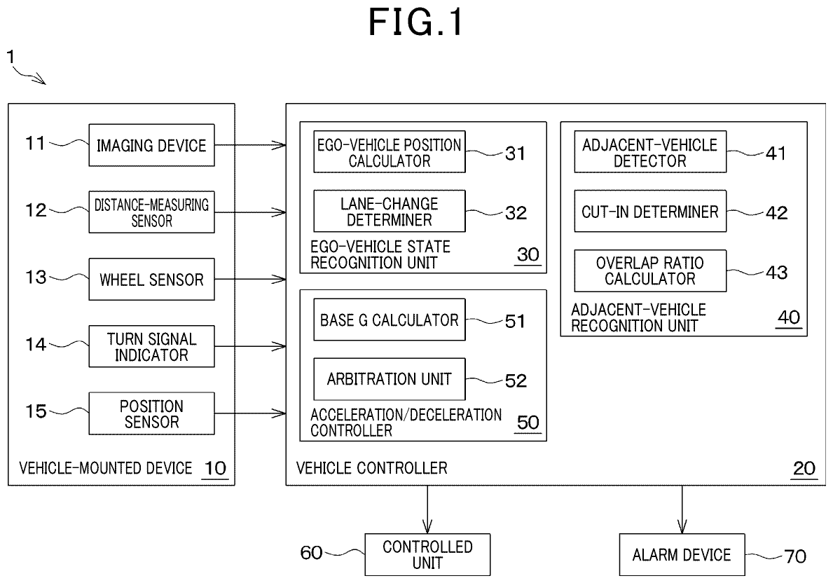

The vehicle control system 1 includes, for example, as shown in FIG. 1, the vehicle-mounted devices 10, the vehicle controller 20, the controlled units 60, and the alarm device 70. The vehicle control system 1 is configured to acquire various types of information regarding the ego vehicle V1 and surroundings thereof from the vehicle-mounted devices 10. The vehicle controller 20 performs internal processing using the various types of information and outputs command signals to the control device 60 and the alarm device 70 as necessary.

The vehicle-mounted devices 10 includes the imaging devices 11, the distance-measuring sensors 12, the wheel sensor 13, the turn signal indicator 14, and the position sensor 15. The vehicle-mounted devices 10 is connected to the vehicle controller 20 via, for example, a network such as an in-vehicle LAN or CAN communication, thereby enabling transmission and reception of signals and data with the vehicle controller 20. LAN and CAN are abbreviations for Local Area Network and Controller Area Network, respectively. In FIG. 1, a configuration in which the vehicle controller 20 directly acquires input signals from the vehicle-mounted devices 10 is illustrated as a representative example; however, the present disclosure is not limited to this example, and input of the respective signals and data from the vehicle-mounted devices 10 may be provided to the vehicle controller 20 via an ECU or the like. ECU is an abbreviation for Electronic Control Unit. Further, the vehicle-mounted devices 10 is not limited to the above-described various devices, and may include other devices and sensors such as a steering wheel and a steering angle sensor, and the configuration may be appropriately modified.

The imaging devices 11 are disposed, for example, on a front side, a rear side, and a lateral side of the ego vehicle V1, and capture images of surroundings of the ego vehicle V1. Each of the imaging devices 11 is configured of, for example, a monocular camera or a stereo camera including a plurality of monocular cameras, and detects objects around the ego vehicle V1 and white lines on a road by analyzing captured image using a known image analysis technique. Each of the imaging devices 11 works to detect, for example, a preceding vehicle traveling ahead in a traveling lane in which the ego vehicle V1 is traveling (hereinafter referred to as the ego lane), the adjacent vehicle traveling in a traveling lane adjacent to the ego lane (hereinafter referred to as an adjacent lane), and the white lines of each traveling lane. The imaging devices 11 detect, for example, whether the turn signal indicators of the preceding vehicle and the adjacent vehicle are blinking, and output the above-described result of detection to the vehicle controller 20.

The distance-measuring sensors 12 are disposed, for example, on a front side, a rear side, and a lateral side of the ego vehicle V1 similarly to the imaging device 11. Each of the distance-measuring sensors 12 works to measure a distance between the ego vehicle V1 and an object present around the ego vehicle V1. Each of the distance-measuring sensors 12 may be implemented by a laser radar, an ultrasonic sensor, or LiDAR. LiDAR is an abbreviation for Light Detection And Ranging. Each of the distance-measuring sensors 12 outputs, for example, information about a distance between the ego vehicle V1 and another object present around the ego vehicle V1, such as the preceding vehicle and the adjacent vehicle, to the vehicle controller 20.

The wheel sensors 13 include, for example, wheel speed sensors attached to respective wheels of the ego vehicle V1, and a controller that calculate a vehicle speed of the ego vehicle V1 using outputs from the wheel speed sensors. Each wheel speed sensor measures a rotational speed of a corresponding wheel to which the wheel speed sensor is attached. The controller integrates, for example, the rotational speeds detected by the respective wheel speed sensors to calculate the vehicle speed (i.e., the speed of the ego vehicle V1), and generates a signal indicative of the calculated vehicle speed. The wheel sensors 13 output information about the speed of the ego vehicle V1 to the vehicle controller 20.

The turn signal indicator 14 is operated by an input switch disposed near the steering wheel of the ego vehicle V1, and blinks in response to an operation by the driver. The turn signal indicator 14 outputs direction information indicating a right or left turn and a lane change of the ego vehicle V1 to the vehicle controller 20.

The position sensor 15 includes, for example, an azimuth sensor that measures a forward azimuth of the ego vehicle V1, and a GPS receiver. GPS is an abbreviation for Global Positioning System, and measures the position of a vehicle using radio waves from artificial satellites. The position sensor 15 acquires information on a traveling direction and a current position of the ego vehicle V1, and outputs the information to the vehicle controller 20.

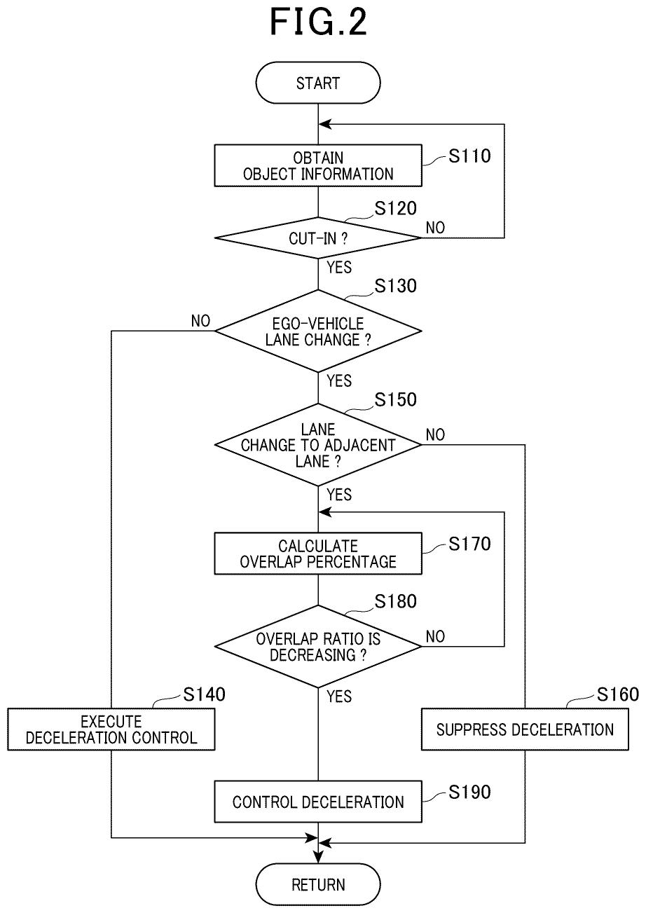

The vehicle controller 20 is implemented by a microcomputer including a CPU, a RAM, a ROM, and a nonvolatile rewritable memory, which are not shown. The vehicle controller 20 reads and executes a computer program stored in the ROM or the nonvolatile rewritable memory, which is a non-transitory tangible recording medium. By executing the computer program, a method corresponding to the computer program is executed. Specifically, the vehicle controller 20 executes various control processes such as a control task in accordance with the computer program illustrated in FIG. 2. CPU, RAM, and ROM are abbreviations for Central Processing Unit, Random Access Memory, and Read Only Memory, respectively. The vehicle controller 20 includes, for example, the ego-vehicle state recognition unit 30, the adjacent-vehicle recognition unit 40, and the acceleration/deceleration controller 50, and functions as a vehicle control apparatus for the ego vehicle V1.

The ego-vehicle state recognition unit 30 recognizes a state of the ego vehicle V1 itself, such as a traveling direction, a current position, and presence/absence of a lane change of the ego vehicle V1, using various types of information acquired from the vehicle-mounted devices 10. The ego-vehicle state recognition unit 30 includes, for example, the ego-vehicle position calculator 31 and the lane-change determiner 32. The ego-vehicle position calculator 31 works to determine a road on which the ego vehicle V1 is traveling, a traveling lane on which the ego vehicle V1 is moving, and the traveling direction in which the ego vehicle V1 is heading, using information from the imaging device 11 and the position sensor 15. The lane-change determiner 32 executes determination processing of presence/absence of a lane change of the ego vehicle V1 and a direction of the lane change, using information from the imaging device 11 and the turn signal indicator 14.

The adjacent-vehicle recognition unit 40 recognizes a state of the adjacent vehicle, such as presence/absence of the adjacent vehicle, a distance between the adjacent vehicle and the ego vehicle V1, and presence/absence of a cut-in by the adjacent vehicle, using various types of information acquired from the vehicle-mounted devices 10. The adjacent-vehicle recognition unit 40 includes, for example, the adjacent-vehicle detector 41, the cut-in determiner 42, and the overlap ratio calculator 43. The adjacent-vehicle detector 41 obtains, for example, information on presence/absence of an object around the ego vehicle V1 and a distance between the object and the ego vehicle V1 from the imaging devices 11 and the distance-measuring sensors 12, and detects the adjacent vehicle around the ego vehicle V1. The cut-in determiner 42 acquires, for example, information on a traveling direction of the adjacent vehicle, a relative speed of the adjacent vehicle relative to the ego vehicle V1, and presence/absence of blinking of a turn indicator of the adjacent vehicle from the imaging devices 11 and the distance-measuring sensors 12, and determines whether the adjacent vehicle is attempting to cut in ahead of the ego vehicle V1, that is, into a predetermined region ahead of the ego lane. The predetermined region ahead is, for example, a region within a predetermined distance from the ego vehicle V1, in other words, a region having a possibility of collision of another vehicle with the ego vehicle V1. The overlap ratio calculator 43 calculates, when it is determined that a cut-in by the adjacent vehicle occurs, an overlap ratio, which is a degree of overlap between the ego vehicle V1 and the adjacent vehicle in a vehicle-width direction of the ego vehicle V1 in a region in which the ego vehicle V1 is scheduled to travel.

The acceleration/deceleration controller 50 performs an acceleration control task or a deceleration control task for the ego vehicle V1 in response to an operation performed by a driver or a command outputted from the system, and performs various calculations necessary for these control tasks. The acceleration/deceleration controller 50 also performs an acceleration/deceleration control task for avoiding a collision between the ego vehicle V1 and an object detected around the ego vehicle V1, and suppresses the deceleration control task so as not to give the driver an unnecessary feeling of deceleration in a situation where a collision possibility is low. The acceleration/deceleration controller 50 includes, for example, the base G calculator 51 and an arbitration unit 52.

The base G calculator 51 calculates, for example, various types of G necessary for setting a target speed of the ego vehicle V1, that is, an acceleration G or a deceleration G that is a ratio of acceleration or deceleration to gravitational acceleration. The arbitration unit 52 performs arbitration of the various types of G calculated by the base G calculator 51 in accordance with a condition of the ego vehicle V1, and also performs correction of the deceleration G in vehicle control for deceleration suppression described later. The arbitration unit 52 performs, for example, arbitration between a target acceleration or a target deceleration required for inter-vehicle distance control (ACC) when a preceding vehicle is present in front of the ego vehicle V1 and a target acceleration or a target deceleration required for a set speed of the ego vehicle V1 when no preceding vehicle is present, and adopts one of these. ACC is an abbreviation for Adaptive Cruise Control. Further, when it is determined that a cut-in by an adjacent vehicle occurs and that the ego vehicle V1 performs a lane change, the arbitration unit 52 gives priority to suppression of deceleration control and adopts a target deceleration in deceleration suppression control. Details thereof will be described later.

In addition, in a normal acceleration/deceleration control mode for collision avoidance, the acceleration/deceleration controller 50 calculates, for example, a TTC obtained by dividing a distance between the ego vehicle V1 and a detected object by a relative speed, performs a collision determination at a point in time when the TTC becomes equal to or less than a predetermined threshold, and executes an acceleration/deceleration control task when there is a possibility of a collision with the detected object. TTC is an abbreviation for Time To Collision. The acceleration/deceleration controller 50 may, for example, execute calculations and determination processing necessary for the collision determination, such as the TTC, in the base G calculator 51, or may include a collision determination unit that executes such calculations and determination processing, and the configuration thereof may be changed as appropriate.

The controlled units 60 include various actuators related to operation of the ego vehicle V1 and ECUs that control operations of the actuators. The controlled units 60 are operated in response to control signals outputted from the vehicle controller 20. Examples of the controlled units 60 include actuators, such as an accelerator pedal, a brake pedal, a steering wheel, and a shift lever, and ECUs for controlling these actuators of the ego vehicle V1.

The alarm device 70 operates a display, a speaker, or the like (not shown) mounted on the ego vehicle V1, and provides predetermined warnings to an occupant such as a driver of the ego vehicle V1 by any method such as images, sound, or vibration. The alarm device 70 provides, for example, notification of various types of information such as detection of an adjacent vehicle, detection of or a possibility of an interruption by the adjacent vehicle, and execution or suppression of vehicle control such as acceleration/deceleration control of the ego vehicle V1, in response to control signals outputted from the vehicle controller 20.

The above is a basic configuration of the vehicle control system 1 according to the present embodiment. The vehicle control system 1 performs the acceleration/deceleration control task by the vehicle controller 20 to avoid a collision between the ego vehicle V1 and another object, and executes a deceleration control task to suppress deceleration of the ego vehicle V1 as necessary when an interruption by an adjacent vehicle occurs.

### Vehicle Control

Subsequently, a vehicle control task for the ego vehicle V1 executed by the vehicle control system 1 according to the present embodiment will be described. When predetermined start conditions are satisfied, for example, when ignition of the ego vehicle V1 is turned on, the vehicle control system 1 executes a control program illustrated in FIG. 2. “LC” in FIG. 2 represents a lane change.

After entering the program, the routine proceeds to step S110 wherein the vehicle controller 20 analyzes outputs from the vehicle-mounted devices 10 to derive ego-vehicle information about a current position, a traveling direction, a traveling lane, and a white line of the ego vehicle V1, and object information about a presence/absence of a preceding vehicle and an adjacent vehicle and a distance to a detected object. Then, the vehicle controller 20 executes various types of tasks in step S120 and subsequent steps based on the various types of information acquired in step S110.

The routine proceeds to step S120 wherein it is determined whether there is an interruption by an adjacent vehicle in front of the ego vehicle V1. For example, the cut-in determiner 42 performs the above interruption determination based on whether an adjacent vehicle is detected in a region in front of the ego vehicle V1 by the adjacent-vehicle detector 41 and whether a turn signal of the adjacent vehicle which indicates a lane side of the ego vehicle V1 is blinking. Steps S110 to S120 serve as an adjacent vehicle detecting task to detect an adjacent vehicle in an adjacent lane and a cut-in determining task to determine the presence/absence of an interruption by the adjacent vehicle. If a YES answer is obtained in step S120, then the routine proceeds to step S130. Alternatively, if a NO answer is obtained, then the routine returns back to step S110.

In step S130, the lane-change determiner 32 determines whether the ego vehicle V1 performs a lane change or not using information such as operation information about the turn signal indicator 14, a steered amount of the ego vehicle V1, and a relative position of the ego vehicle V1 with respect to a detected white line on the road. If a YES answer is obtained, then the routine proceeds to step S150. Alternatively, if a NO answer is obtained, then the routine proceeds to step S140.

In step S140, the acceleration/deceleration controller 50 executes the deceleration control task for the ego vehicle V1 using information on a relative position and a relative speed of a cut-in vehicle with respect to the ego vehicle V1. For example, the acceleration/deceleration controller 50 calculates a target deceleration for preventing the ego vehicle V1 from colliding with the cut-in vehicle, and outputs a control signal to the controlled units 60 such that the ego vehicle V1 achieves the target deceleration. Accordingly, driving assistance for avoiding a collision between the ego vehicle V1 and the cut-in vehicle is performed, thereby ensuring traveling safety.

In step S150, the lane-change determiner 32 determines whether the ego vehicle V1 performs a lane change to a lane in which the adjacent vehicle is traveling, using information similar to that in step S130 and position information about the adjacent vehicle. Steps S130 and S150 serve as a lane-change determining task to determine whether the ego vehicle V1 performs a lane change. If a YES answer is obtained in step S150, then the routine proceeds to step S170. Alternatively, if a NO answer is obtained in step S150, then the routine proceeds to step S160.

When a negative determination is made in step S150, a situation shown in FIG. 3 may be cited. For example, it is assumed that the ego vehicle V1 is traveling in a first lane DL1 of a road having three or more lanes in one direction, and that the adjacent vehicle V2 traveling in the same direction as the ego vehicle V1 is detected in a second lane DL2 adjacent to the first lane DL1. Under this assumption, when the adjacent vehicle V2 is attempting to cut in to a forward region of the first lane DL1 of the ego vehicle V1, and a driver of the ego vehicle V1 is about to perform a lane change to a third lane DL3 on an opposite side from the second traveling lane DL2, an operation in step S160 is executed. The situation demonstrated in FIG. 3 corresponds to a case in which, although deceleration processing is normally executed by the ego vehicle V1 due to presence of a cut-in vehicle, the driver of the ego vehicle V1 intentionally performs a lane change to a lane opposite to the adjacent vehicle V2 because the driver intends to avoid decelerating the ego vehicle V1.

In step S160, the acceleration/deceleration controller 50 executes a deceleration suppressing task to suppress the deceleration control for the ego-vehicle V1. Examples of suppression of deceleration control include canceling deceleration control with respect to a cut-in vehicle, or changing a target deceleration in the deceleration control to a predetermined value equal to or less than 0 G, such that a deceleration of the ego vehicle V1 is less than a deceleration generated by the normal deceleration control in step S140. Specifically, the suppression of deceleration control is performed to avoid controlling deceleration or to limit the target deceleration to the predetermined value or less, thereby preventing the ego vehicle V1 from being decelerated more than necessary, so to speak, for releasing deceleration. In addition, examples of a start timing of the suppression of deceleration control include a time when the turn signal indicator 14 is operated before the ego-vehicle V1 performs a lane change, a time when the ego vehicle V1 overlaps a white line WL located at a boundary with an adjacent lane, or a time when a distance between the white line WL and the ego vehicle V1 becomes equal to or less than a predetermined value. By the operation in step S160, deceleration control for the ego-vehicle V1 is suppressed, an unnecessary deceleration feeling for the driver of the ego-vehicle V1 is reduced, and traveling comfort is be ensured in the ego-vehicle V1.

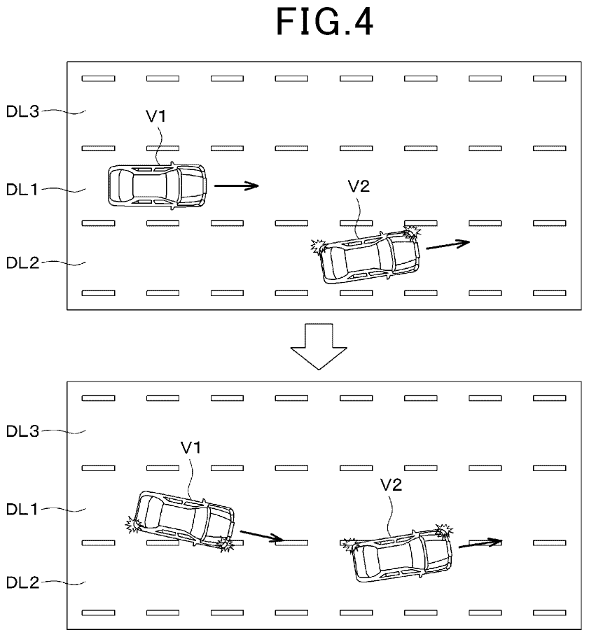

When an affirmative determination is made in step S150, a situation demonstrated in FIG. 4 may be cited. Preconditions of the situation shown in FIG. 4 are the same as those in FIG. 3. Under these preconditions, when the adjacent vehicle V2 is attempting to cut in to a forward region of the first lane DL1 on which the ego vehicle V1 is traveling, and the driver of the ego vehicle V1 is about to perform a lane change to the second lane DL2 in which the adjacent vehicle V2 has been traveling, operations in step S170 and subsequent steps are executed. That is, the situation demonstrated in FIG. 4 corresponds to a case in which, although the deceleration operation is normally executed by the ego vehicle V1 due to presence of a cut-in vehicle, the driver of the ego vehicle V1 intentionally performs a lane change to the lane in which the adjacent vehicle V2 has been traveling because the driver intends to avoid decelerating the ego vehicle V1.

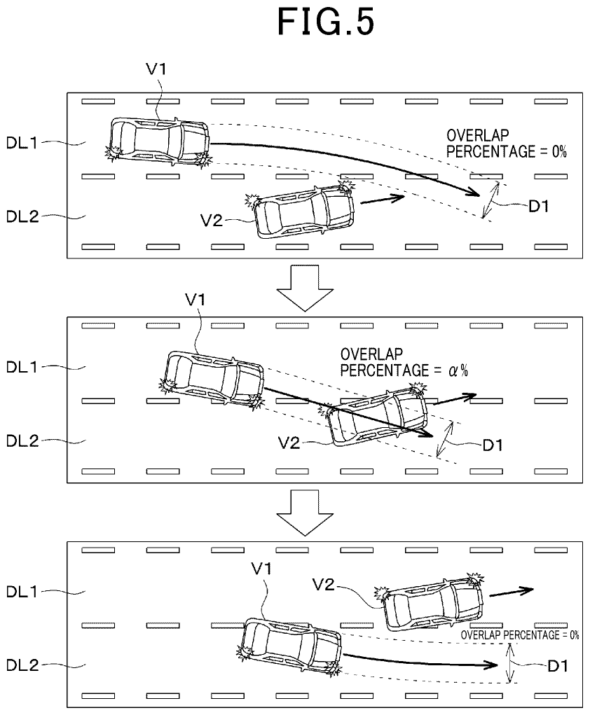

In step S170, for example, the overlap ratio calculator 43 calculates an overlap ratio (e.g., an overlap percentage) between the ego vehicle V1 and the adjacent vehicle V2. For example, a case demonstrated in FIG. 5 is considered in which the adjacent vehicle V2 is attempting to cut in from the second lane DL2 to the first lane DL1, which is an ego-vehicle lane, and the ego vehicle V1 is about to perform a lane change from the first lane DL1 to the second lane DL2. The overlap ratio calculator 43 works to determine a region within a width of the ego vehicle V1, centered on a virtual line that passes through the center of the ego vehicle V1 in a vehicle-width direction D1 and extends along a vehicle longitudinal direction of the ego vehicle V1, as a planned traveling region. Then, the overlap ratio calculator 43 calculates, as an overlap ratio (i.e., an overlap percentage), a degree of overlap between the planned traveling region and the detected adjacent vehicle V2 in the vehicle-width direction D1 of the ego vehicle V1. The overlap ratio is calculated to be, for example, 0% immediately after start of lane change and after completion of lane change of the ego vehicle V1 and the adjacent vehicle V2, and α % (0<α23 100) while the two vehicles are performing lane changes. The overlap ratio calculator 43 calculates the overlap ratio during a predetermined period from start to end of the lane change of the ego vehicle V1.

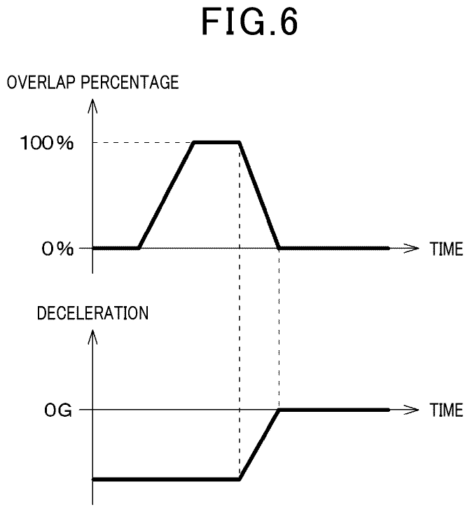

In step S180, the overlap ratio calculator 43 determines whether the overlap ratio calculated in step S170 is decreasing. Examples of a decrease in the overlap ratio include a case in which the overlap ratio peaks out from a maximum value (for example, 100%), as shown in FIG. 6, or a case in which the overlap ratio becomes equal to or less than a predetermined threshold. If a YES answer is obtained in step S180, then the routine proceeds to step S190. Alternatively, if a NO answer is obtained in step S180, then the routine returns back to step S170 and repeats the operations in steps S170 and S180 at a predetermined interval.

In step S190, the acceleration/deceleration controller 50 sets a target value of deceleration of the ego vehicle V1 to a value determined as a function of the overlap ratio, as shown in FIG. 6, and outputs control signals corresponding to the target deceleration to the controlled units 60. Specifically, the lane change example described above with reference to FIG. 5 is considered. In this example, the overlap ratio starts from 0%, increases from a certain time to 100%, then peaks out from 100%, and finally returns to 0%. The acceleration/deceleration controller 50 sets a predetermined deceleration as a target value and executes the deceleration control task during a period in which the overlap ratio increases from 0% to 100%, such that the ego vehicle V1 does not collide with the adjacent vehicle V2 that is attempting to cut in front of the ego vehicle V1. Subsequently, from a time point at which the overlap ratio starts to peak out from 100%, the acceleration/deceleration controller 50 decreases the target deceleration in accordance with the overlap ratio and suppresses deceleration control for the ego vehicle V1. At this time, for example, as shown in FIG. 6, the acceleration/deceleration controller 50 linearly decreases the target deceleration in the deceleration control mode such that the target deceleration becomes 0 G when the overlap ratio is 0%. Accordingly, when the ego vehicle V1 performs a lane change to a lane in which the cut-in vehicle has been traveling, a collision between the ego vehicle V1 and the cut-in vehicle is avoided, while excessive deceleration of the ego vehicle V1, that is, providing an unnecessary deceleration feeling to the driver of the ego vehicle V1, is suppressed, and traveling comfort is ensured in the ego vehicle V1.

The suppression of deceleration control in step S190 is not limited to the example shown in FIG. 6. For example, start of suppression of the target deceleration may be set to a timing at which the overlap ratio starts to peak out from a maximum value and becomes equal to or less than a predetermined threshold. The target deceleration may be decreased in a curved manner in accordance with the overlap ratio. Further, for example, a final target deceleration when the overlap ratio peaks out and becomes 0% may be set to a value other than 0 G. As described above, a manner of releasing deceleration in step S190 may be changed as appropriate.

After step S140, step S160, or step S190, the routine returns back to step S110 so that the vehicle controller 20 repeats the above series of operations until predetermined end conditions are satisfied, for example, until ignition is turned off. In addition, the operation in steps S140, S160, or S190 corresponds to a deceleration control task to avoid an accidental collision of the ego vehicle V1 with the adjacent vehicle V2. Further, the operation in step S160 or S190 corresponds to a deceleration suppressing control task when it is determined that an interruption by an adjacent vehicle occurs and that the ego vehicle V1 performs a lane change.

The above is a basic operation example of vehicle control achieved by the vehicle control system 1. In addition, vehicle control by the vehicle control system 1 is not limited to the above-described example. An order of the respective processing and determination contents may be changed within a possible range, processing other than the above-described processing may be added, and various modifications may be made as appropriate. For example, in addition to the operation in step S140, S160, or S190, the vehicle controller 20 may output a drive signal to the alarm device 70 to notify the driver of the ego vehicle V1 of detection of a cut-in vehicle and execution or suppression of deceleration control. Further, for example, after step S120, when a relative speed and a relative position of a detected adjacent vehicle are equal to or greater than predetermined values and a possibility of collision with the ego vehicle V1 is low, the vehicle controller 20 may execute cancellation or suppression of deceleration control.

According to the present embodiment, the vehicle control system 1, as described above, includes the lane-change determiner 32 that determines whether the ego vehicle V1 performs a lane change, the adjacent-vehicle detector 41 that detects an adjacent vehicle, the cut-in determiner 42 that determines a cut-in by the adjacent vehicle, and the acceleration/deceleration controller 50 that executes acceleration/deceleration control for the ego vehicle V1. The acceleration/deceleration controller 50 executes acceleration/deceleration control for collision avoidance between the ego vehicle V1 and the adjacent vehicle, and suppresses deceleration control when it is determined that a cut-in by the adjacent vehicle occurs and that the ego vehicle V1 performs a lane change. Accordingly, when an adjacent vehicle is about to cut in front of the ego vehicle V1 and the ego vehicle V1 is attempting to performing a lane change, the vehicle control system 1 suppresses deceleration control, thereby suppressing provision of an unnecessary deceleration feeling to the driver of the ego vehicle V1, and is capable of ensuring traveling safety and comfort in the ego vehicle V1. Further, the vehicle control system 1 has the following features.

When the cut-in determiner 42 determines that a cut-in by an adjacent vehicle occurs, and the lane-change determiner 32 determines that the ego vehicle V1 performs a lane change to a lane on an opposite side from a lane in which the adjacent vehicle is traveling, the acceleration/deceleration controller 50 suppresses deceleration control. Accordingly, when the ego vehicle V1 performs a lane change to a side opposite from the cut-in vehicle, provision of an unnecessary deceleration feeling to the driver is suppressed, and traveling comfort can be ensured.

The vehicle control system 1 further includes the overlap ratio calculator 43 that calculates the overlap ratio between the ego vehicle V1 and the adjacent vehicle V2 in the vehicle-width direction D1 of the ego vehicle V1. When the cut-in determiner 42 determines that a cut-in by the adjacent vehicle V2 is occurring, and the lane-change determiner 32 determines that the ego vehicle V1 is about to perform a lane change to a lane in which the adjacent vehicle V2 has been traveling before the cut-in, the acceleration/deceleration controller 50 changes a deceleration of the ego vehicle V1. At this time, in suppressing deceleration control, the acceleration/deceleration controller 50 changes the deceleration of the ego vehicle V1 in accordance with the overlap ratio calculated by the overlap ratio calculator 43. Accordingly, when the ego vehicle V1 is about to perform a lane change to a lane in which the cut-in vehicle has been traveling, provision of an unnecessary deceleration feeling to the driver of the ego vehicle V1 is suppressed while avoiding a collision, and traveling safety and comfort can be ensured.

### Other Embodiments

Although the present disclosure has been described in terms of the embodiment, it is understood that the present disclosure is not limited to the embodiment and structures thereof. The present disclosure includes various modifications and variations within the scope of equivalents. In addition, various combinations and forms, and further, other combinations and forms including only one element thereof, more than one element thereof, or less than all elements thereof, also fall within the scope and spirit of the present disclosure.

The vehicle controller 20 and the method thereof described in the present disclosure may be implemented by a special-purpose computer provided by configuring a processor and a memory programmed to execute one or more functions embodied by a computer program. Alternatively, the vehicle controller 20 and the method thereof described in the present disclosure may be implemented by a special-purpose computer provided by configuring a processor with one or more dedicated hardware logic circuits. Alternatively, the vehicle controller 20 and the method thereof described in the present disclosure may be implemented by one or more special-purpose computers each provided by a combination of a processor and a memory programmed to execute one or more functions and a processor configured by one or more hardware logic circuits. Further, the computer program may be stored, as instructions executed by a computer, in a computer-readable non-transitory storage medium.

In addition, in each of the above-described embodiments, it should be understood that constituent elements of the embodiments are not necessarily essential, except for cases where the elements are explicitly stated to be essential or are considered to be obviously essential in principle. Further, in each of the above-described embodiments, when numerical values such as numbers, quantities, or ranges of constituent elements are mentioned, the present disclosure is not limited to such specific numerical values, except for cases where the values are explicitly stated to be essential or are clearly limited to specific numbers in principle. Further, in each of the above-described embodiments, when shapes, positional relationships, or the like of constituent elements are mentioned, the present disclosure is not limited to such shapes or positional relationships, except for cases where such shapes, positional relationships, or the like are explicitly stated or are clearly limited in principle.

This disclosure is realized by the following aspects.

### First Aspect

A vehicle control apparatus configured to control an operation of an ego vehicle (V1), comprising: (a) a lane-change determiner (32) which determines whether the ego vehicle changes lanes using an input signal from a vehicle-mounted device of the ego vehicle; (b) an adjacent-vehicle detector (41) which works to detect, in an adjacent lane adjacent to a lane in which the ego vehicle is traveling, an adjacent vehicle moving in the same direction as the ego vehicle; (c) a cut-in determiner (42) which is configured to determine whether the adjacent vehicle is about to cut in ahead of the ego vehicle into the lane in which the ego vehicle is traveling; and (d) an acceleration/deceleration controller (50) which works to execute acceleration control or deceleration control for the ego vehicle to avoid a collision between the ego vehicle and the adjacent vehicle. The acceleration/deceleration controller works to suppress the deceleration control when the cut-in determiner determines that the adjacent vehicle is attempting to perform a cut-in in front of the ego vehicle and the lane-change determiner determines that the ego vehicle is attempting to perform a lane change.

### Second Aspect

The vehicle control apparatus as set forth in the above-described first aspect, wherein, when the cut-in determiner determines that the adjacent vehicle is attempting to perform the cut-in and the lane-change determiner determines that the ego vehicle is about to change lanes to a lane on an opposite side to a lane in which the adjacent vehicle is traveling, the acceleration/deceleration controller suppresses the deceleration control.

### Third Aspect

The vehicle control apparatus as set forth in the above-described first aspect, further comprising an overlap ratio calculator configured to calculate, in a width direction of the ego vehicle, an overlap ratio between the ego vehicle and the adjacent vehicle, wherein, when the cut-in determiner determines that the adjacent vehicle performs the cut-in and the lane-change determiner determines that the ego vehicle changes lanes to a lane in which the adjacent vehicle was traveling before the cut-in, the acceleration/deceleration controller changes a deceleration rate of the ego vehicle in suppressing the deceleration control in accordance with the overlap ratio calculated by the overlap ratio calculator.

### Fourth Aspect

A vehicle control method executed by a vehicle controller installed in an ego vehicle, comprising: (a) determining whether the ego vehicle changes lanes using an input signal from a vehicle-mounted device of the ego vehicle; (b) detecting, in a lane adjacent to a lane in which the ego vehicle is traveling, an adjacent vehicle traveling in the same direction as the ego vehicle; (c) determining whether the adjacent vehicle is attempting to perform a cut-in ahead of the ego vehicle into the lane in which the ego vehicle is traveling; and (d) executing deceleration control to avoid a collision between the ego vehicle and the adjacent vehicle. In executing the deceleration control, when it is determined that the adjacent vehicle performs the cut-in and it is determined that the ego vehicle changes lanes, the deceleration control is suppressed.

### Fifth Aspect

A vehicle control program executed by a vehicle controller installed in an ego vehicle. The vehicle control program causes the vehicle controller to execute: (a) a process of determining whether the ego vehicle changes lanes using an input signal from a vehicle-mounted device of the ego vehicle; (b) a process of detecting, in a lane adjacent to a lane in which the ego vehicle is traveling, an adjacent vehicle traveling in the same direction as the ego vehicle; (c) a process of determining whether the adjacent vehicle is attempting to perform a cut-in ahead of the ego vehicle into the lane in which the ego vehicle is traveling; and (d) a process of executing deceleration control to avoid a collision between the ego vehicle and the adjacent vehicle. In executing the deceleration control, when it is determined that the adjacent vehicle is attempting to perform the cut-in and it is determined that the ego vehicle changes lanes, the deceleration control is suppressed.

### Sixth Aspect

A non-transitory computer-readable medium storing instructions that, when executed by one or more processors of a vehicle controller installed in an ego vehicle, cause the one or more processors to: (a) determine whether the ego vehicle changes lanes based on an input signal from a vehicle-mounted device of the ego vehicle; (b) detect, in a lane adjacent to a lane in which the ego vehicle is traveling, an adjacent vehicle traveling in a same direction as the ego vehicle; (c) determine whether the adjacent vehicle is attempting to cut in ahead of the ego vehicle into the lane in which the ego vehicle is traveling; and (d) execute deceleration control to avoid a collision between the ego vehicle and the adjacent vehicle. In executing the deceleration control, when it is determined that the adjacent vehicle is attempting to cut in and it is determined that the ego vehicle changes lanes, the one or more processors suppress the deceleration control.

What is claimed is:

1. A vehicle control apparatus configured to control an operation of an ego vehicle, comprising:
a lane-change determiner which determines whether the ego vehicle changes lanes using an input signal from a vehicle-mounted device of the ego vehicle;
an adjacent-vehicle detector which works to detect, in an adjacent lane adjacent to a lane in which the ego vehicle is traveling, an adjacent vehicle moving in the same direction as the ego vehicle;
a cut-in determiner which is configured to determine whether the adjacent vehicle is about to cut in ahead of the ego vehicle into the lane in which the ego vehicle is traveling; and
an acceleration/deceleration controller which works to execute acceleration control or deceleration control for the ego vehicle to avoid a collision between the ego vehicle and the adjacent vehicle,
wherein the acceleration/deceleration controller works to suppress the deceleration control when the cut-in determiner determines that the adjacent vehicle is attempting to perform a cut-in in front of the ego vehicle and the lane-change determiner determines that the ego vehicle is attempting to perform a lane change.

2. The vehicle control apparatus as set forth in claim 1, wherein, when the cut-in determiner determines that the adjacent vehicle is attempting to perform the cut-in and the lane-change determiner determines that the ego vehicle is about to change lanes to a lane on an opposite side to a lane in which the adjacent vehicle is traveling, the acceleration/deceleration controller suppresses the deceleration control.

3. The vehicle control apparatus as set forth in claim 1, further comprising an overlap ratio calculator configured to calculate, in a width direction of the ego vehicle, an overlap ratio between the ego vehicle and the adjacent vehicle, wherein, when the cut-in determiner determines that the adjacent vehicle performs the cut-in and the lane-change determiner determines that the ego vehicle changes lanes to a lane in which the adjacent vehicle was traveling before the cut-in, the acceleration/deceleration controller changes a deceleration rate of the ego vehicle in suppressing the deceleration control in accordance with the overlap ratio calculated by the overlap ratio calculator.

4. A vehicle control method executed by a vehicle controller installed in an ego vehicle, comprising:
determining whether the ego vehicle changes lanes using an input signal from a vehicle-mounted device of the ego vehicle;
detecting, in a lane adjacent to a lane in which the ego vehicle is traveling, an adjacent vehicle traveling in the same direction as the ego vehicle;
determining whether the adjacent vehicle is attempting to perform a cut-in ahead of the ego vehicle into the lane in which the ego vehicle is traveling; and
executing deceleration control to avoid a collision between the ego vehicle and the adjacent vehicle,
wherein, in executing the deceleration control, when it is determined that the adjacent vehicle performs the cut-in and it is determined that the ego vehicle changes lanes, the deceleration control is suppressed.

5. A vehicle control program executed by a vehicle controller installed in an ego vehicle, the vehicle control program causing the vehicle controller to execute:
a process of determining whether the ego vehicle changes lanes using an input signal from a vehicle-mounted device of the ego vehicle;
a process of detecting, in a lane adjacent to a lane in which the ego vehicle is traveling, an adjacent vehicle traveling in the same direction as the ego vehicle;
a process of determining whether the adjacent vehicle is attempting to perform a cut-in ahead of the ego vehicle into the lane in which the ego vehicle is traveling; and
a process of executing deceleration control to avoid a collision between the ego vehicle and the adjacent vehicle,
wherein, in executing the deceleration control, when it is determined that the adjacent vehicle is attempting to perform the cut-in and it is determined that the ego vehicle changes lanes, the deceleration control is suppressed.
